(19) United States
(12) Patent Application Publication
(10) Pub. No.: US 2024/0090739 A1
(43) Pub. Date: Mar. 21, 2024

(54) CONVEYOR WAREWASHER WITH CAMERA SYSTEM

(71) Applicant: ILLINOIS TOOL WORKS INC., Glenview, IL (US)

(72) Inventors: Björn S. HIMMELSBACH, Offenburg (DE); Marian SIEBERT, Willstätt (DE)

(21) Appl. No.: 18/466,416

(22) Filed: Sep. 13, 2023

(30) Foreign Application Priority Data
Sep. 16, 2022 (DE) 10 2022 123 745.1

(51) Int. Cl. A47L 15/24; A47L 15/00; G06T 7/00; G06V 10/20

(52) U.S. Cl. CPC A47L 15/24; A47L 15/0018; G06T 7/0004; G06V 10/20; A47L 2501/36; G06T 2207/30164

(57) ABSTRACT

A conveyor warewasher includes at least one washing zone, at least one rinsing zone, a conveyor and a camera system arranged above or below the conveyor and configured to capture at least one image of a portion of the conveyor, preferably continuously or at predefined or definable times and/or events. The camera system includes at least one camera and a transparent surface element arranged in a region of the field of view of the camera, in the form of a transparent glass or plastic panel, wherein the at least one camera is at least partly or in some areas separated from the portion of the conveyor optically covered by the camera system, via the transparent surface element. A heating device is associated with the transparent surface element for heating, in particular continuously or as needed, at least one portion of the transparent surface element.

### TECHNICAL FIELD

The present invention relates generally to the field of industrial washing, and in particular to a conveyor warewasher.

Accordingly, the invention relates in particular to a belt conveyor warewasher or a rack conveyor warewasher.

### BACKGROUND

Conveyor warewashers are used in the commercial sector. In contrast to domestic dishwashers, in which the washware to be cleaned remains stationary in the machine during cleaning, in conveyor warewashers the washware is conveyed through different treatment zones of the conveyor warewasher.

In the case of conveyor warewashers, the washware, for example dishes, pots, glasses, cutlery, and other utensils to be cleaned, are conveyed through a plurality of treatment zones, for example through at least one pre-washing zone, at least one main washing zone, at least one post-washing zone or pre-rinsing zone, at least one fresh water rinsing zone, and at least one drying zone. However, different types of washware require different treatment parameters for the individual process steps due to their application, their degree of soiling, their shape, and the material used. However, in today's conveyor warewashers, there is usually no automatic differentiation of the types of washware, so that the conventional systems are often designed as a compromise in order to be usable for several different types of washware.

A conveyor warewasher as defined in the preamble of claim 1 is already generally known from the prior art, at least in principle. For example, a rack conveyor warewasher is known from publication U.S. Pat. No. 6,530,996 B2, in which the washware to be cleaned is delivered to the respective treatment zones of the rack conveyor warewasher after being presorted in dish racks. In this conventional conveyor warewasher, sensors are provided that can be used in order to indirectly determine the type of washware to be cleaned, namely by detecting an identification feature attached to the rack. Depending on the detected identification feature, a suitable washing and/or rinsing program of the conveyor warewasher is selected.

A further conveyor warewasher is known from the publication DE 196 08 030C1, in which additional spray systems are switched on or off in the individual treatment zones of the conveyor warewasher in order to change the impact route in the treatment zones, depending upon the type and soiling of the washware to be cleaned.

It is known from the publication DE 10 2005 021 101A1 to switch additional spray nozzles on and off in a conveyor warewasher in order to thus reduce the consumption of rinsing water, depending upon the conveyance speed of the washware in the rinsing zone of the conveyor warewasher. Sensors are provided, which sense the presence of the washware at the entrance of the conveyor warewasher, wherein the system automatically reduces the conveyance speed when the amount of the washware entering the conveyor warewasher decreases.

However, the currently known systems for the automatic detection of types of washware have various disadvantages in their implementation.

For example, conventional systems have only been configured in order to detect glasses and cutlery when these types of washware are stored in specially coded glass or cutlery racks. For this purpose, the racks are encoded with magnets and are then detected by a magnetic sensor.

The disadvantage to this approach is that specially coded rinsing racks are necessary for this purpose, and if they are not used by the operator of the warewasher, detection is not possible.

Heavily soiled washware, such as pots, baking trays, or GN containers, are typically made of metal. In the conventional approaches, these are detected by an inductive sensor at the machine inlet.

The disadvantage here, however, is that the maximum possible switching distance is limited with this type of sensor, and it is thus only possible to detect the washware that is positioned at the very edge of the conveyor belt. A correct function is thus also only ensured here when the cleaning staff have previously been trained accordingly.

It must thus be noted that no defect-free operation and in particular no defect-free detection is ensured in the systems currently known for the detection of washware. In addition, several sensors are required in order to detect different types of washware, making the entire system relatively complex and expensive.

### SUMMARY

The present invention solves the problem of providing a conveyor warewasher having at least one washing zone and at least one rinsing zone, which, despite the reduction of the consumption of resources (fresh water, chemicals, and energy), can provide good treatment results in operation for all types of washware.

In particular, it is intended to simplify the detection of the washware on the conveyor warewasher, wherein the susceptibility to errors in the washware detection is simultaneously reduced, and wherein in particular no special measures must be carried out on the part of the cleaning staff in order to ensure the detection of the washware.

In particular, it is intended to simplify the detection of the washware on the conveyor warewasher, wherein the susceptibility to errors in the washware detection is simultaneously reduced, and wherein in particular no special measures must be carried out on the part of the cleaning staff in order to ensure the detection of the washware.

This problem is solved according to the invention by the subject-matter of independent claim 1, wherein advantageous further developments are specified in the dependent claims.

Accordingly, the invention relates to a conveyor warewasher for cleaning washware, wherein the conveyor warewasher comprises at least one washing zone and at least one rinsing zone, as well as a conveyor apparatus for conveying the washware through the at least one washing zone and the at least one rinsing zone.

With a view to the optimized and, in particular, simplified detection of the washware, the conveyor warewasher according to the invention is provided with a camera system which is arranged above, below, or laterally to the transport device and is designed to record at least one image of an area of the transport device, preferably continuously or at predetermined or definable times and/or events.

For this purpose, the camera system comprises at least one camera and a transparent flat element arranged in a region of the field of view of the at least one camera, which is in particular designed in the form of a transparent glass or plastic disc. The at least one camera of the camera system is separated from the transport device, and in particular from the area of the transport device optically covered by the camera system, at least partially or in some areas by means of the transparent flat element.

In particular, it is provided herein that a heating device is associated with the transparent flat element for heating, in order to heat, in particular continuously or as needed, at least one region of the transparent flat element.

The provision of a heating device associated with the transparent flat element provides decisive advantages that positively influence the reduced susceptibility to errors of detection of washware that can be achieved using the camera system. As the transparent flat element can be heated at least in certain areas, it is possible to ensure that the quality of the image recorded by the camera system is not impaired by condensation. Moreover, the transparent flat element provides effective protection of the at least one camera of the camera system.

According to preferred implementations of the conveyor warewasher according to the invention, it is provided that the conveyor warewasher comprises a control device associated with the heating device, which is designed to control the heating device such that the transparent flat element is heated to a temperature which is above the characteristic condensation temperature prevailing in the region of the camera system.

Condensation temperature refers to the temperature from which a substance (water here) condenses at a given pressure, i.e., transitions from the gaseous to the liquid aggregate state. The condensation point corresponds to the dew point when condensing water in air, which means the temperature at which the air is saturated with water vapor.

By using the heating device to heat the flat element to a temperature above the characteristic condensation temperature, a build-up of condensation in the optical area of the camera system is effectively prevented. Without such a heating device, water would condense on the transparent flat element in front of the camera by increasing vapors in the supply area of the conveyor warewasher. This would increasingly lead to camera vision limitations and cause image blurring to the point of object obscurity. This is particularly pronounced in standby phases of the conveyor warewasher and for large objects that open the machine curtains wide, and for long periods.

According to preferred embodiments of the conveyor warewasher according to the invention, it is provided that the camera system comprises at least one temperature sensor for detecting a temperature of the flat element, the at least one temperature sensor preferably being part of a control loop with which the temperature of the flat element is set to a temperature above a characteristic condensation temperature prevailing in the region of the camera system and in particular in the region of the flat element.

This further development is thus a particularly effective, yet simple, solution for optimally maintaining the image capture of the camera system over a long time with low resource requirements.

According to preferred implementations of the camera system of the conveyor warewasher according to the invention, it is provided that the transparent flat element is embodied as a thermally toughened glass pane, in particular as a single-pane safety glass. Of course, other implementations of the transparent flat element are also possible here.

Thermally toughened glass panes are characterized by increased temperature, impact and shock resistance compared to normal flat glass. In addition, thermally toughened glass has the advantage that it breaks into small compact cube pieces when shattering, effectively reducing the risk of cut and impact injuries.

According to embodiments of the camera system of the conveyor warewasher according to the invention, it is provided that the transparent flat element is designed in particular as an at least partially or regionally transparent glass pane, in particular made of a thermally toughened glass, wherein the heating device comprises a metal layer that is applied to the flat element and in particular to a surface of the flat element facing in the direction of the transport device, wherein this layer may be vapor-deposited or similar. Such a metallically vaporized glass pane thus implements the integration of an invisible heater with the advantage of uniform temperature distribution, while the glass pane is still transparent over its entire surface.

Alternatively or in addition to a metallically vaporized glass pane, it is conceivable to use a foil heating element that is arranged on a surface of the flat element and, in particular, glued onto it. This embodiment has the advantage that a camera system can be retrofitted with a corresponding heating device, if necessary.

Advantageously, the foil heater should have a window area that is adapted to the field of view of the at least one camera, which is designed to be adapted to the field of view of the at least one camera such that the at least one image of the area of the transport device can be captured through the window area by means of the at least one camera.

In order to ensure a particularly protected solution for the camera system, it is provided in accordance with further embodiments of the solution according to the invention that the at least one camera of the camera system comprises a corresponding housing wherein the at least one camera is accommodated, in particular at least partially or regionally hermetically sealed off from the outside atmosphere.

Particularly in connection with the housing associated with the at least one camera of the camera system, it is conceivable that the camera system is preferably arranged in a detachable or interchangeable manner in front of an inlet tunnel of the conveyor warewasher, as viewed in the transport direction of the transport device.

The area of the conveyor apparatus monitored by the camera system, continuously or at predetermined or at determinable times and/or events, should preferably be positioned upstream of the at least one washing zone and preferably within an inlet tunnel of the conveyor warewasher, when viewed in the direction of conveyance of the conveyor apparatus.

In other words, the camera system is preferably located within a lateral and upwardly closed inlet tunnel of the conveyor warewasher. In this way, it is ensured that predeterminable, defined conditions can be present in the image capture.

In a further development of the camera system, it is provided that an illumination device, which is in particular synchronized with the image capture of the camera system, is associated with the camera system for preferably defined illumination or lighting of the area of the conveyor apparatus.

Preferably, the illumination device comprises at least one light source which is designed to provide, in particular, homogeneous and preferably diffuse lighting or illumination of at least one region of the area of the transport device with light that is preferably at a color temperature mainly lying between 5200 to 5700 Kelvin.

Mounting the camera system with the illumination device that is preferably associated with the camera system within the inlet tunnel of the conveyor warewasher has decisive advantages compared to a camera position outside of the inlet tunnel. While external mounting would be ideal for protecting the camera system, when the camera system is mounted externally, it is relatively effort-intensive to find the right moment to capture images. Another disadvantage is the increased effort involved in training the service personnel and the increasing time required for the start-up of the warewasher.

Conversely, when the camera system is positioned within the inlet tunnel of the conveyor warewasher, the moment of image capture can be defined relatively simply. Additionally, the start-up of the warewasher on site is not affected. The camera system can already be fully assembled at the factory, wherein no increase in the training for the service personnel is required and the operator of the warewasher does not need to perform a lengthy start-up. A further major advantage is the independence of the ambient lighting when assembling the camera system within the inlet tunnel of the conveyor warewasher. The lighting may be designed such that there are always fixedly defined ambient conditions.

Thus, it is particularly suitable that the transparent flat element of the camera system is further designed such that it serves to separate the illumination device at least partially or regionally from the transport device, and in particular from the area of the transport device optically covered by means of the camera system.

According to implementations of the solution according to the invention, it is provided that the camera system has an image processing device assigned to it, which is designed for, in particular, optional preprocessing of at least one image recorded by the camera system, for object detection purposes, in particular with neural networks of the, in particular, optionally preprocessed image, and for feature extraction and classification of objects contained in the image.

In particular, it is provided in this context that the image processing device is designed to perform object detection with neural networks on the image, in particular an optionally preprocessed image, according to a model-based method, wherein the model-based method assumes a predetermined or, in particular, machine-learnable, specific shape of the objects contained in the image.

Alternatively or additionally, the image processing device is designed to perform object detection with neural networks on the image, in particular an optionally preprocessed image, according to a pixel-oriented method, according to an edge-oriented method, according to a region-oriented method, and/or according to a texture-oriented method, in order to extract features of the objects contained in the image with regard to their shape, size, position, orientation, and/or material.

### BRIEF DESCRIPTION OF THE DRAWING

In the following, the invention will be described in more detail with reference to the accompanying drawing based on an exemplary embodiment of the conveyor warewasher according to the invention.

The following are shown:

FIG. 1 a schematic longitudinal sectional view of a conveyor warewasher according to an exemplary embodiment of the invention.

### DETAILED DESCRIPTION

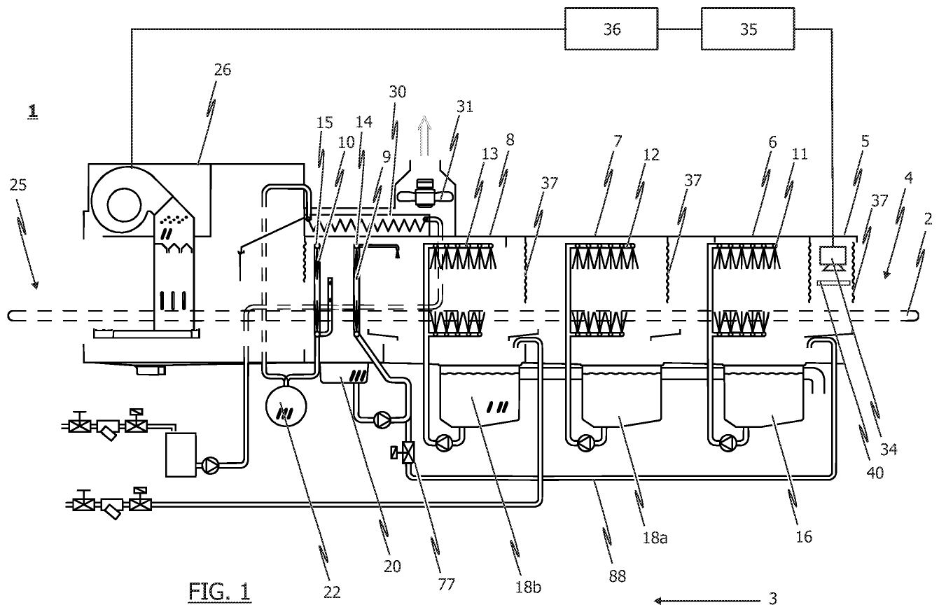

FIG. 1 shows a conveyor warewasher 1 with a conveyor apparatus 2 for conveying washware not shown in the drawings through the conveyor warewasher 1 in a direction of conveyance 3.

The conveyor apparatus 2 can be, for example, a conveyor belt, which is preferably configured as a multi-member plastic conveyor belt and is continuously driven by an electric drive not shown in FIG. 1, so that the washware placed upon the conveyor belt 2 is conveyed through the various treatment zones 6, 7, 8, 9, 10, and 26 of the conveyor warewasher 1 according to the illustration in FIG. 1.

Typically, the washware conveyed in the direction of conveyance 3 is placed upon the conveyor apparatus or conveyor belt 2 in the area of the inlet 4. According to the direction of conveyance 3 indicated by the arrow, the washware is then conveyed from the inlet 4 into an inlet tunnel 5.

The conveyor warewasher 1 according to the first embodiment of the present invention has at least one washing zone, for example as shown in FIG. 1, a pre-washing zone 6, as well as a first main washing zone 7 and a second main washing zone 8, which are arranged downstream of the pre-washing zone 6 when viewed in the direction of conveyance 3.

In the conveyor warewasher 1 shown in FIG. 1, a post-washing zone 9 and a rinsing zone 10 downstream of the post-washing zone 9 are arranged downstream of the at least one washing zone 6, 7, 8 when viewed in the direction of conveyance 3.

In the illustration according to FIG. 1, the conveyor apparatus 2 is shown as a circumferential conveyor belt. However, conveyor racks in which the not explicitly shown washware is inserted and which are placed on the top of the conveyor belt are also conceivable as the conveyor apparatus 2.

When viewed in the direction of conveyance 3, the washware received either directly on the conveyor belt 2 or held by racks runs in the direction of conveyance 3 through the inlet tunnel 5, the subsequent pre-washing zone 6, the first main washing zone 7, the second main washing zone 8, the post-washing zone 9, the rinsing zone 10, a drying zone 26, and into an outlet path 25.

Spray nozzles 11, 12, 13, 14 and 15 are respectively associated with the aforementioned treatment zones 6, 7, 8, 9, and 10 of the conveyor warewasher 1, via which nozzles liquid is sprayed onto the washware conveyed by the conveyor apparatus 2 through the respective treatment zones 6, 7, 8, 9, and 10. Each treatment zone 6, 7, 8, 9, and 10 is associated with a tank 16, 18, 20, and 22 in which sprayed liquid is received and/or in which liquid is provided for the spray nozzles of the respective zones. In the conveyor warewasher 1 shown in FIG. 1, rinsing liquid is sprayed onto the washware, not shown in the illustrations, in the form of fresh water, which may be pure or mixed with further additives such as rinsing agents, via the spray nozzles 15 of the rinsing zone 10 arranged above and below or to the side of the conveyor belt.

A portion of the sprayed rinsing liquid is conveyed from zone to zone in a cascading system counter to the direction of conveyance 3 of the washware. The remaining portion is guided directly into the pre-wash tank 16 via a valve 77 and a bypass line 88.

The sprayed rinsing liquid is collected in the tank 20 (post-wash tank 20) of the post-washing zone 9, from which it is conveyed via a pump system to the spray nozzles 14 (post-wash nozzles 14) of the post-washing zone 9. In the post-washing zone 9, washing liquid is rinsed from the washware. The liquid resulting from this flows into the wash tank 18b of the second main washing zone 8, is usually provided with a cleaning agent and then sprayed onto the washware by a pumping system via the nozzles 13 (wash nozzles 13) of the second main washing zone 8.

Liquid flows from the wash tank 18b of the second main washing zone 8 into the wash tank 18a of the first main washing zone 7. From there, the liquid is again sprayed onto the washware by a further pump system via the wash nozzles 12 of the first main washing zone 7. From the wash tank 18a of the first main washing zone 7, the liquid then flows into the pre-wash tank 16 of the pre-washing zone 6. Liquid in the pre-wash tank 16 is sprayed onto the washware by a pumping system via the pre-wash nozzles 11 of the pre-washing zone 6 in order to remove coarse impurities from the washware.

The individual rinsing systems of the treatment zones 6, 7, 8, 9, and 10 ensure that the washware is sprayed from both the top and the bottom.

The respective zones 6, 7, 8, 9, and 10 of the conveyor warewasher 1 can be separated from one another via separating curtains 37. In the embodiment shown in FIG. 1, the inlet tunnel 5 itself is also separated from the inlet 4 via a separating curtain 37. The provision of separating curtains 37 can prevent washing liquid and rinsing liquid from splashing out and steam from escaping from the conveyor warewasher.

The aforementioned drying zone 26 follows the rinsing zone 10 in the direction of conveyance 3 of the washware. In the drying zone 26, the washware is dried with dry and heated air in order to blow off or dry the moisture that is present on the washware. In order to maintain the moisture content of the air within a range that is favorable for drying, it is conceivable, for example, to supply room air via an opening, for example through the exit opening for the washware. The warm and moistened air is extracted from the drying zone 26, for example, by means of a fan 31 via a further opening.

It is advantageous for the exhaust air from the drying zone 26 to pass through a device for heat recovery 30, in which a condenser can be provided. The heat recovery device 30 serves to recover at least a portion of the heat energy contained in the exhaust air.

In today's belt/rack conveyor warewashers, the washware is conveyed through a plurality of treatment zones, such as pre-washing zones, main washing zones, post-washing zones, rinsing zones, and drying zones.

As already indicated, different types of washware in the treatment zones of the conveyor warewasher require different treatment parameters. However, with the currently known conveyor warewashers, there is no automatic differentiation of the types of washware to be treated, so that conventional systems are typically designed as a compromise, such that they are more or less efficient for multiple types of washware. This approach leads to the fact that significantly more resources (energy, water, chemicals, etc.) are generally used in order to treat the washware than would actually be necessary.

The conveyor warewasher 1 according to the invention, as shown for example in FIG. 1, is characterized in that the conveyor warewasher 1 has a camera system 34, which is disposed above the conveyor apparatus 2 and is configured in order to take at least one image of an area of the conveyor apparatus 2, preferably continuously or at predetermined or determinable times and/or events.

The camera system 34 preferably has an image processing device 35 assigned to it, which is designed in particular for the—in particular optional—preprocessing of the at least one image recorded by the camera system 34, for the segmentation of the—in particular optionally preprocessed—image, and for feature extraction and classification of objects (parts of items to be rinsed) that are contained in the image.

Furthermore, according to embodiments, it is possible to provide an evaluation device which is designed to evaluate and determine, on the basis of the performed classification, whether washware of at least one of the following washware classes was present in the area of the transport washing machine 1 at the time the image was recorded:
cutlery or pieces of cutlery;
pots, pans, or GN containers;
glasses, in particular drinking glasses;
trays or tray-like objects;
plates, cups, or bowls;
utensils;
other washware;
mixed washware;
plastic washware; or
no washware.

As indicated in FIG. 1, the camera system 34 is preferably located within the inlet tunnel 5 of the conveyor warewasher 1.

The conveyor warewasher 1 further has a control device 36, schematically shown in FIG. 1. In particular, the control device 36 is designed to control different controllable components of the conveyor warewasher 1, such as the respective pumps and valves, in accordance with a predefined or definable program sequence; and thereby, to be able to set suitable process parameters in the individual treatment zones of the conveyor warewasher 1.

As shown in the drawings, the control device 36 is connected, in particular via a suitable communication link, to the camera system 34 or the image processing/evaluation device 35 in order to query, continuously or at predetermined times or events, the washware class—as determined by the evaluation device—of the washware that is fed to the conveyor warewasher 1.

The term “washware category” as used herein is a summary of the different types of washware into categories, which together form a classification and/or category of washware. The types of a category of washware have in common that they are optimally treatable according to the same or similar treatment parameters.

The camera system 34 of the conveyor warewasher shown schematically in FIG. 1 comprises at least one camera and a transparent flat element 40 that is arranged in a region of the field of view of the at least one camera. The transparent flat element 40 consists, in particular, of a transparent glass or plastic disc, wherein this advantageously consists of a thermally toughened glass disc, in particular made of single-layer safety glass.

The at least one camera of the camera system 34 is separated from the transport device 2, and in particular from the area of the transport device 2 optically covered by means of the camera system 34, at least partially or regionally by the transparent flat element 40. In particular, it is provided in this context that, in order to prevent condensation from forming, a heating device is assigned to the transparent flat element 40 in order to heat at least one region of the transparent flat element 40, in particular continuously or as required.

Advantageously, a control device 36 is assigned to the heating device, which is designed to control the heating device such that the transparent flat element 40 is heated to a temperature that is above the characteristic condensation temperature prevailing in the area of the camera system 34.

To this end, the camera system 34 can have a temperature sensor that is designed to sense a temperature of the flat element 40. The temperature sensor is preferably part of a control circuit with which the temperature of the flat element 40 is set to the temperature above a characteristic condensation temperature prevailing in the area of the camera system 34 and, in particular, in the area of the flat element 40.

Various embodiments can be considered for the implementation of the heating device:

In particular, it is conceivable that the heating device is arranged on the flat element 40, in particular on a surface of the flat element 40 facing towards the conveyor 2, which can in particular be in the form of a metal layer evaporated on the flat element 40 or the like applied.

Alternatively, it is conceivable that the heating device comprises a foil heating element that is arranged on a surface of the flat element 40. In this context, the foil heater should comprise a window area that is adapted to the field of view of the at least one camera of the camera system 34, which is designed such that the window area is adapted to the field of view of the at least one camera such that the at least one image of the area of the transport device 2 can be recorded through the window area with the aid of the at least one camera.

Preferably, a housing which is associated with the at least one camera of the camera system 34 is provided, wherein the at least one camera is accommodated, in particular such that it is at least partially or regionally hermetically sealed off from the external atmosphere.

As shown schematically in FIG. 1, it is preferably provided that the camera system 34 is arranged within or—as seen in the transport direction of the transport device 2—in front of an inlet tunnel of the conveyor warewasher, preferably in a detachable or exchangeable manner.

Although not shown in FIG. 1, it is convenient that the camera system 34 has an illumination device assigned to it, in particular such that this illumination device is synchronized with the image recording of the camera system 34, for preferably defined illumination or lighting of the area of the transport device 2.

The illumination device is preferably also accommodated in the housing of the camera system 34.

The invention is not limited to the embodiment schematically shown in FIG. 1, but results from a summary of all features disclosed herein.

1. A conveyor warewasher for cleaning washware, wherein the conveyor warewasher comprises at least one washing zone and at least one rinsing zone as well as a conveyor for conveying the washware through the at least one washing zone and the at least one rinsing zone, characterized in that
the conveyor warewasher comprises a camera system, which is arranged above, below, or laterally to the conveyor and is configured so as to capture, continuously or at predefined or definable times and/or events, at least one image of a portion of the conveyor, wherein the camera system comprises at least one camera and a transparent surface element arranged in a region of the field of view of the at least one camera,
wherein the at least one camera is at least partly or in some areas separated from the conveyor, via the transparent surface element, wherein a heating device is associated with the transparent surface element for heating, continuously or as needed, at least a portion of the transparent surface element.

2. The conveyor warewasher according to claim 1, wherein the conveyor warewasher comprises a control device associated with the heating device and configured so as to control the heating device such that the transparent surface element is heated to a temperature above the characteristic condensation temperature prevailing in the region of the camera system.

3. The conveyor warewasher according to claim 1, wherein the camera system comprises at least one temperature sensor for sensing a temperature of the surface element, wherein the at least one temperature sensor is part of a control loop with which the temperature of the surface element is adjusted to a temperature above the characteristic condensation temperature prevailing in the region of the surface element.

4. The conveyor warewasher according to claim 1,
wherein the transparent surface element is configured as a thermally biased glass panel.

5. The conveyor warewasher according to claim 1,
wherein the transparent surface element is configured as a partly or in some areas transparent glass panel, and wherein the heating device is arranged on a top surface of the surface element facing in the direction of the conveyor.

6. The conveyor warewasher according to claim 1,
wherein the transparent surface element is configured as an at least partly or in some areas transparent glass pane, and wherein the heating device comprises a metal layer, which is vapor deposited or similarly applied to the surface element.

7. The conveyor warewasher according to claim 1,
wherein the heating device comprises a foil heating body arranged on a top surface of the surface element.

8. The conveyor warewasher according to claim 7, wherein the foil heating body comprises a window region adapted to the field of view of the at least one camera, which is configured so as to be adapted to the field of view of the at least one camera such that the at least one image of the portion of the conveyor can be captured through the window region with the aid of the at least one camera.

9. The conveyor warewasher according to claim 1,
wherein a housing associated with the at least one camera of the camera system is provided, in which housing the at least one camera is received, being at least partly or in some areas hermetically sealed against the external atmosphere.

10. The conveyor warewasher according to claim 1,
wherein the camera system is arranged in or—when viewed in the transport direction of the conveyor—in front of an inlet tunnel of the conveyor warewasher, in a detachable or exchangeable manner.

11. The conveyor warewasher according to claim 1,
wherein a lighting device, which is synchronized with the image capture of the camera system, is associated with the camera system for the defined illumination or lighting of the region of the conveyor.

12. The conveyor warewasher according to claim 11,
wherein the lighting device has at least one light source, which is configured so as to enable a homogeneous and diffuse lighting or illumination of at least one region of the region of the conveyor with light at a color temperature in the main part of between 5,200 and 5,700 Kelvin.

13. The conveyor warewasher according to claim 11,
wherein the transparent surface element of the camera system is further configured such that the lighting device is separated at least partly or in some areas from the conveyor, via said surface element.

14. The conveyor warewasher according to claim 1,
wherein an image processing device is associated with the camera system, which device is configured so as to pre-process the at least one image captured by the camera system, to segment the pre-processed image, to extract features, and to classify objects contained in the image.

15. The conveyor warewasher according to claim 14, wherein the image processing device is configured so as to carry out an object detection with neuronal networks on the optionally pre-processed image according to a model-based method, wherein the model-based method assumes a predefined or machine-learnable, specific shape of the objects contained in the image; and/or
wherein the image processing device is configured so as to carry out an object detection with neuronal networks on the pre-processed image according to a pixel-oriented method, according to an edge-oriented method, according to a region-oriented method, and/or according to a texture-oriented method in order to extract features of the objects contained in the image with respect to shape, size, location, orientation, and/or material.
